(19) United States
(12) Patent Application Publication
(10) Pub. No.: US 2011/0102702 A1
(43) Pub. Date: May 5, 2011

(54) DISPLAY DEVICE

(75) Inventors: Yasushi Nakano, Tokyo (JP); Hitoshi Azuma, Yokohama (JP); Tomio Yaguchi, Sagamihara (JP)

(73) Assignee: Hitachi Displays, Ltd.

(21) Appl. No.: 12/907,363

(22) Filed: Oct. 19, 2010

(30) Foreign Application Priority Data
Oct. 29, 2009 (JP) 2009-248594

(51) Int. Cl. G02F 1/1333; H01J 1/62

(52) U.S. Cl. 349/58; 313/504

(57) ABSTRACT

There is provided a display device including two substrates disposed opposite to each other with a liquid crystal interposed therebetween. A TFT circuit layer is formed on a surface of one of the paired substrates on the liquid crystal side. The one of the paired substrates is formed at least of glass. A resin layer is interposed between the TFT circuit layer and the glass substrate, in order to prevent the TFT circuit layer from being cracked even if a thickness of the glass substrate is reduced.

### CLAIM OF PRIORITY

The present application claims priority from Japanese Patent Application JP 2009-248594 filed on Oct. 29, 2009, the content of which is hereby incorporated by reference into this application.

### FIELD OF THE INVENTION

The present invention relates to a display device, and more particularly to a display device in which display unit is formed on a surface of a glass substrate.

### BACKGROUND OF THE INVENTION

A liquid crystal display device (panel) is configured, for example, such that two glass substrates are disposed opposite to each other with a liquid crystal interposed between the glass substrates. Then, a display unit is formed on the surface of one of the paired glass substrates on the liquid crystal side. The paired glass substrates function as an envelope of the liquid crystal display device. A large number of pixels, each of which includes a liquid crystal element, are arranged in a matrix form in the display unit.

Here, the display unit on the side of one substrate (first substrate) of the paired glass substrates includes an electronic circuit having at least a thin film transistor and a pixel electrode for each pixel. The electronic circuit is formed by laminating a semiconductor layer, an oxidized metal layer, an insulating layer, and the like in a predetermined pattern and order. Such a laminate is hereinafter referred to as a TFT circuit layer for the convenience of the description.

To meet the recent demand for reducing the depth thickness of the liquid crystal display device, the following procedure has been established. First two glass substrates are bonded to each other. Then each of the paired glass substrates is thinned by dipping the side opposite to the liquid crystal into an etchant.

JP-A No. 280548/2003 is an example of related art. In the configuration disclosed in JP-A No. 280548/2003, each of the paired glass substrates of the liquid crystal display device is thinned as described above. Then, a substrate reinforcing layer, for example, formed of resin material is attached to the surface of each glass substrate on the opposite side to the liquid crystal. This is designed to allow the individual thinned substrates to be resistant to bending or impact by attaching the substrate reinforcement layers to each substrate.

However, it has been observed that the liquid crystal display device, in which each of the paired substrates is thinned as described above, is likely to induce cracking in the TFT circuit layer formed on the surface of the first substrate on the liquid crystal side.

The inventors have investigated the cause of the above problem and have found the following facts. In the step of forming the TFT circuit layer on the first substrate formed of glass, tensile residual stress occurs because of the influence on the TFT circuit layer from the first substrate. At the same time, compressive residual stress occurs because of the influence on the first substrate from the TFT circuit layer. As a result, the first substrate is slightly warped when the thickness of the first substrate is reduced. In this case, for example, when a force is applied to return the warped first substrate to the horizontal state, greater stress occurs in the TFT circuit layer, causing the TFT circuit layer to be cracked.

It can also be observed that the phenomenon of cracking of the TFT circuit layer occurs even in the configuration of JP-A No. 280548/2003, in which the substrate reinforcing layer is attached to the surface of each of the paired glass substrates on the opposite side to the liquid crystal.

### SUMMARY OF THE INVENTION

Accordingly, an object of the present invention is to provide a display device in which the TFT circuit layer is prevented from being cracked even if the thickness of the glass substrate is reduced.

A display device according to the present invention includes a glass substrate and a TFT circuit layer with a resin layer interposed therebetween.

For example, the present invention can be configured as follows.

(1) A display device according to the present invention includes a first substrate, a second substrate disposed opposite to the first substrate, and a liquid crystal interposed between the first and second substrates. A TFT circuit layer is formed on a surface of the first substrate on the liquid crystal side. The first substrate is formed at least of glass. The TFT circuit layer is formed on the first substrate with a first resin layer interposed therebetween.

(2) In the display device according to the present invention described in (1), a second resin layer is formed on a surface of the first substrate on the opposite side to the first resin layer.

(3) In the display device according to the present invention described in (1), the first substrate has a thickness of 0.2 mm or less.

(4) In the display device according to the present invention described in (1), the first substrate has a thickness of 0.1 mm or less.

(5) In the display device according to the present invention described in (1), the second substrate is formed of glass. A third resin layer is formed on a surface of the second substrate on the opposite side to the liquid crystal.

(6) In the display device according to the present invention described in (1), the first and second substrates are warped and projected in a direction in which the TFT circuit layer is formed on the first substrate.

(7) A display device according to the present invention is an organic EL display device. The organic EL display device is formed by laminating at least a TFT circuit layer, plural organic EL elements driven by the TFT circuit layer, and a sealing board, in this order on one surface of a substrate. The substrate is at least formed of glass. The TFT circuit layer is formed on the substrate with a first resin layer interposed therebetween.

(8) In the display device according to the present invention described in (7), a second resin layer is formed on a surface of the substrate on the opposite side to the first resin layer.

(9) In the display device according to the present invention described in (7), the substrate has a thickness of 0.2 mm or less.

(10) In the display device according to the present invention described in (7), the substrate has a thickness of 0.1 mm or less.

(11) In the display device according to the present invention described in (7), the sealing board is formed of glass. A third resin layer is formed on a surface of the sealing board on the opposite side to the organic EL elements.

(12) In the display device according to the present invention described in (7), the substrate and the sealing board are warped and projected in a direction in which the TFT circuit layer is formed on the substrate.

It is to be understood that the above descriptions are merely examples, and the present invention is not limited to these examples. Various modifications can be made by those skilled in the art without departing from the technical concept of the present invention.

In the display device according to the present invention, it is possible to prevent the TFT circuit layer from being cracked even if the thickness of the glass substrate is reduced.

Other effects of the present invention will be made clear from the descriptions of the entire specification.

### BRIEF DESCRIPTION OF THE DRAWINGS

FIG. 1 is a cross-sectional view of a first embodiment of a display device according to the present invention;

FIG. 2 is a top view of the first embodiment of the display device according to the present invention;

FIG. 3 is a schematic view of the effect of the present invention, which is also shown in FIGS. 4 and 5;

FIG. 4 is a schematic view of the effect of the present invention, which is also shown in FIGS. 3 and 5;

FIG. 5 is a schematic view of the effect of the present invention, which is also shown in FIGS. 3 and 4;

FIG. 6 is a schematic view of the effect in the first embodiment of the display device according to the present invention;

FIG. 7 is a cross-sectional view of a second embodiment of the display device according to the present invention;

FIG. 8 is a schematic view of the effect in the second embodiment of the display device according to the present invention; and

FIG. 9 is a cross-sectional view of a third embodiment of the display device according to the present invention.

### DETAILED DESCRIPTION OF THE PREFERRED EMBODIMENTS

Hereinafter, preferred embodiments of the present invention will be described with reference to the accompanying drawings. The same or similar components are designated by the same reference numerals throughout the respective figures and embodiments, and the description thereof will be omitted.

### First Embodiment

FIG. 2 is a top view schematically showing a first embodiment of a liquid crystal display device according to the present invention. In FIG. 2, a first substrate SUB1 and a second substrate SUB2 are disposed opposite to each other, with a liquid crystal (not shown) interposed therebetween. The second substrate SUB2 is arranged on the observer side. A backlight (not shown) is provided on the back side of the first substrate SUB1. The area of the second substrate SUB2 is slightly smaller than the first substrate SUB1, so that a side portion SD of the first substrate SUB1 is exposed on the lower side of the figure. A semiconductor device (chip) SEC is mounted on the side portion SD of the first substrate SUB1 on the lower side of the figure. The semiconductor device SEC is a control circuit for driving each pixel in a display area (display unit) AR which will be described later. A sealing material SL is formed in the periphery of the second substrate SUB2 to fix it to the first substrate SUB1. Another function of the sealing material SL is to seal the liquid crystal.

The area surrounded by the sealing material SL is the display area (display unit) AR on the side of the first substrate SUB1. Then, gate signal lines GL and drain signal lines DL are formed on the surface (top surface) of the display area AR on the liquid crystal side. As shown in the figure, the gate signal lines GL extend in the x direction and arranged parallel in the y direction, and the drain signal lines DL extend in the y direction and arranged parallel in the x direction. The area surrounded by each pair of adjacent two gate signal lines GL and each pair of adjacent two drain signal lines DL corresponds to a pixel area. In this way, the display area AR includes a large number of pixels arranged in a matrix form.

FIG. A is an equivalent circuit diagram within the oval area indicated by the dotted line in FIG. 2. As shown in FIG. A, each pixel area includes a thin transistor TFT, a pixel electrode PX, and a counter electrode CT. The thin transistor TFT is turned ON by a signal (scan signal) from the gate line GL. The pixel electrode PX is supplied with a signal from the drain signal line DL through the thin transistor TFT. The counter electrode CT generates an electric field between the pixel electrode PX and the counter electrode CT. The electric field has a component parallel to the surface of the first substrate SUB1, so that the orientation of the liquid crystal molecules changes while remaining parallel to the surface of the first substrate SUB1. The liquid crystal display device of this type is, for example, referred to as a lateral electric field type liquid crystal display device. The counter electrode CT is supplied with a reference signal as a reference to an image signal, for example, through a common signal line CL parallel to the gate signal line GL.

The gate signal lines GL, the drain signal lines DL, and the common signal lines CL are connected to the semiconductor device SEC by leader lines not shown, respectively. In this way, a scan signal is supplied to the gate signal lines GL, an image signal is supplied to the drain signal lines DL, and a reference signal is supplied to the common signal lines CL.

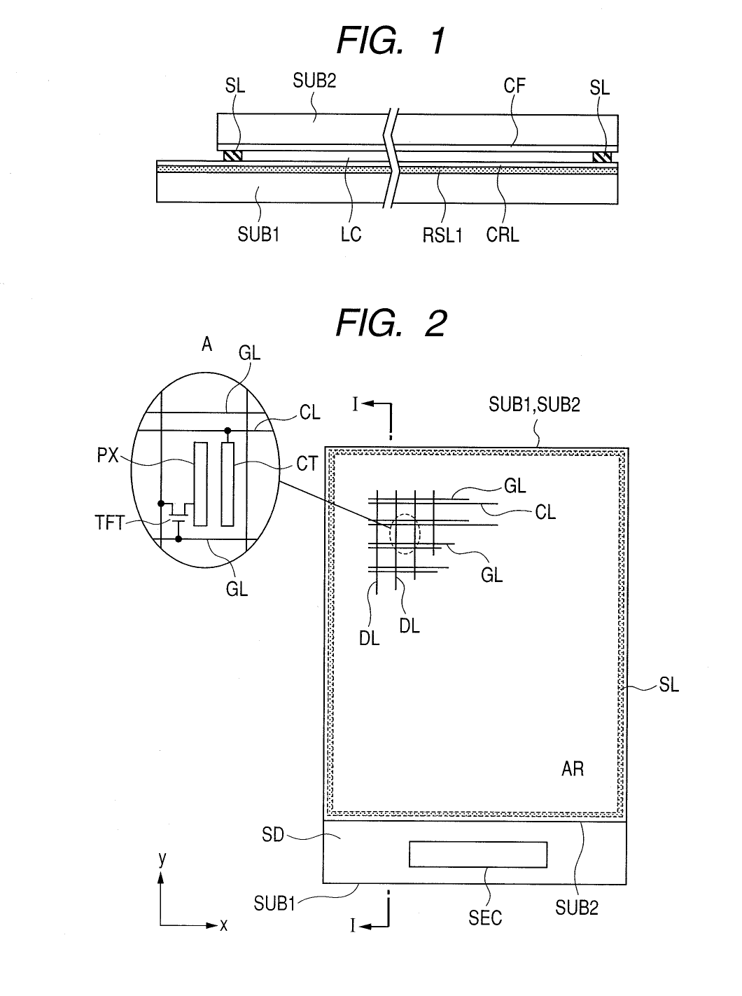

FIG. 1 is a cross-sectional view taken along line I-I in FIG. 2. In FIG. 1, the first substrate SUB1 and the second substrate SUB2 are disposed opposite to each other with a liquid crystal LC interposed therebetween. Then, a resin layer (first resin layer) RSL1 is formed on the surface of the first substrate SUB1 on the side of the liquid crystal LC. A TFT circuit layer CRL is formed on the upper surface of the resin layer RSL1.

The first substrate SUB1 and the second substrate SUB2 are formed of glass. The thickness of each substrate is, for example, 0.2 mm or less. In this case, a non-warped thin panel can be formed using the first substrate SUB1 for example with a thickness of 0.2 to 0.1 mm. A flexible panel that can be warped can be formed using the first substrate SUB1 for example with a thickness of 0.1 mm or less.

The TFT circuit layer CRL is a laminate formed by laminating a metal layer, a semiconductor layer, an oxidized metal layer, an insulating layer, and the like in a predetermined pattern and order. The circuit shown in FIG. 2 is formed in the TFT circuit layer CRL. The metal layer is formed of, for example, of Cr, Al, and the like, forming the gate signal line GL and the drain signal line DL. The semiconductor layer is formed, for example, of amorphous silicon, and the like, forming a semiconductor layer of the thin film transistor TFT. The oxidized metal layer is formed of, for example, Indium Tin Oxide (ITO), and the like, forming the pixel electrode PX and the counter electrode CT. The insulating layer is formed of, for example, silicon oxide film, silicon nitrogen film, and the like, forming an interlayer insulating film between the gate signal line GL and the drain signal line DL, or an insulating film between the pixel electrode PX and the counter electrode CT. The TFT circuit layer CRL configured as described above is typically formed by laminating inorganic material layers. At this time, an oriented film (not shown) is formed to determine the initial orientation of the liquid crystal molecules on the surface of the TFT circuit layer CRL contacting the liquid crystal LC.

Then, the TFT circuit layer CRL is formed on the upper surface of the resin layer RSL1 formed in the first substrate SUB1. This makes it possible to prevent the TFT circuit layer CRL from being cracked. The reason will be described below.

In FIG. 1, for example, color filter layers CF are formed on the surface of the second substrate SUB2 on the liquid crystal side, to color the image layer in the display area AR. In addition to the color filters CF, a black matrix, a flattening film, and the like may also be formed on the surface of the second substrate SUB2 on the liquid crystal side, but they are omitted in FIG. 1.

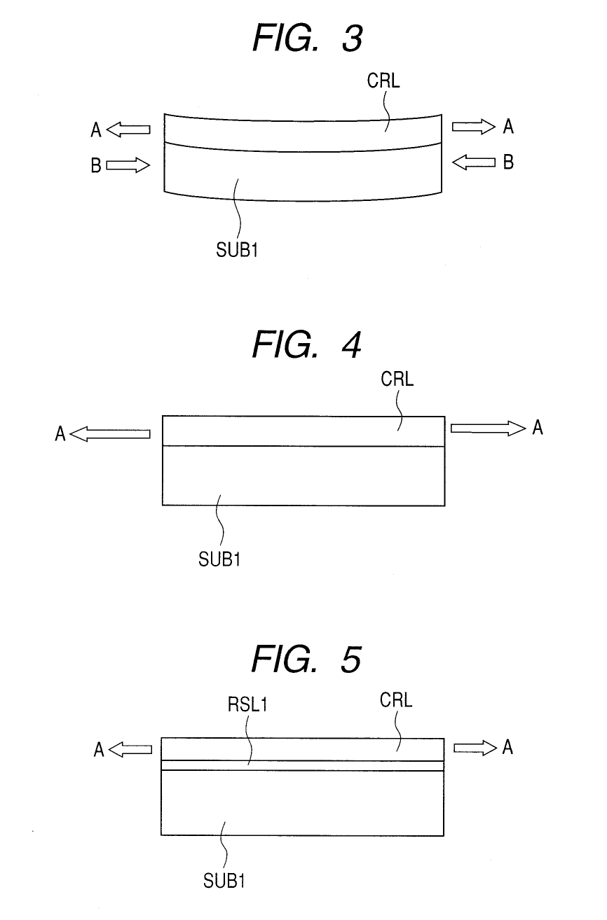

FIG. 3 is a view schematically showing the reason why the TFT circuit layer CRL is less likely to be cracked. FIG. 3 shows the case in which the resin layer RSL1 is not formed between the first substrate SUB1 and the TFT circuit layer CRL.

When the TFT circuit CRL is formed on the surface of the first substrate SUB1, tensile residual stress (indicated by the arrow A in the figure) occurs, in which the TFT circuit layer CRL is subjected to a pulling force from the first substrate SUB1. At the same time, compressive residual stress (indicated by the arrow B in the figure) occurs in the first substrate SUB1, in which the first substrate SUB1 is subjected to a compressive force from the TFT circuit layer CRL. For this reason, both the first substrate SUB1 and the TFT circuit layer CRL are warped and projected, as shown in FIG. 3, on the side of the TFT circuit layer CRL. However, the warpage of the first substrate SUB1 is shown exaggerated in FIG. 3.

Thus, in order to correct the warpage of the first substrate SUB1 and return it to the initial state, as shown in FIG. 4, the first substrate SUB1 is made in a horizontal state, causing the TFT circuit layer to extend. As a result, greater stress occurs, so that cracking is likely to occur in the TFT circuit layer CRL. Thus, it goes without saying that when the first substrate SUB1 is warped and projected on the side of the TFT circuit layer CRL, cracking is much more likely to occur in the TFT circuit layer CRL. When the TFT circuit layer CRL is cracked, the first substrate SUB1 is also cracked.

On the other hand, as shown in FIG. 5, when the resin layer RSL1 is interposed between the first substrate SUB1 and the TFT circuit layer CRL, the residual stress on the TFT circuit layer CRL is reduced to a lower level. This is because the material of the resin layer RSL1 is softer than the material (glass) of the first substrate SUB1. As a result, cracking is less likely to occur in the TFT circuit layer CRL, leading to a reduced risk of cracking in the first substrate SUB1. In this case, the same effect can be obtained when the first substrate SUB1 is warped and projected on the side of the TFT circuit layer CRL.

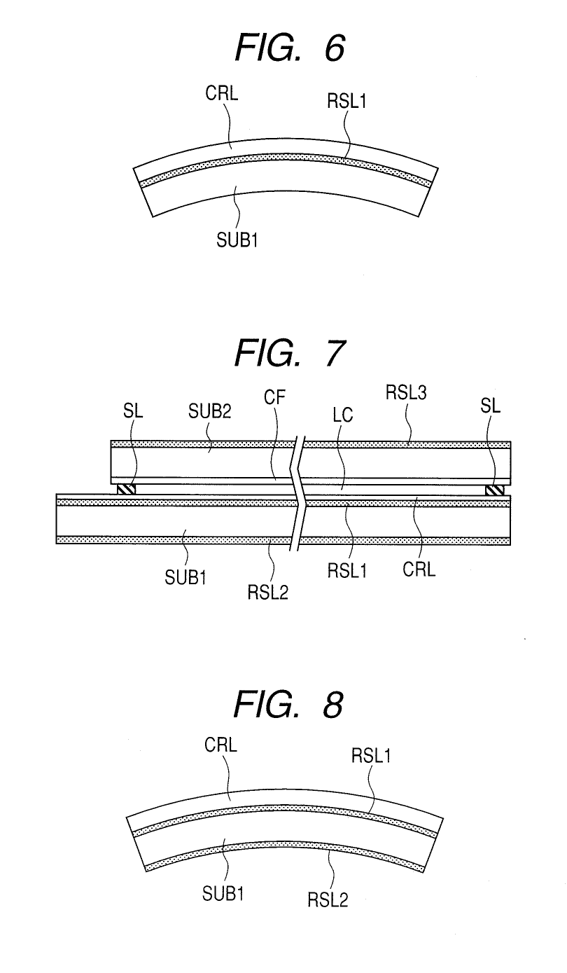

FIG. 6 is a view in which the combination of the first substrate SBU1 and the TFT circuit layer CRL with the resin layer SRL1 interposed therebetween is warped and projected on the side of the TFT circuit layer CRL until the TFT circuit layer CRL is cracked. Here, the first substrate SUB1 has a thickness of 0.2 mm. Under the same conditions, the combination of the first substrate SUB1 and the TFT circuit layer CRL without the resin layer SRL1 interposed therebetween is warped and projected on the side of the TFT circuit layer CRL until the TFT circuit layer CRL is cracked. In this case, it has been observed that the amount of warpage of the former is up to about 1.5 times more than that of the latter. Further, the strength of the first substrate SUB1 has been tested by dropping an iron ball on the combination of the first substrate SUB1 and the TFT circuit layer CRL with the resin layer SRL1 interposed therebetween. In this test, it has been observed that the strength of the first substrate SUB1 is almost five times more than the strength of the combination of the first substrate SUB1 and the TFT circuit layer CRL without the resin layer SRL1 interposed therebetween.

### Second Embodiment

In the first embodiment described above, no substrate reinforcing layer is formed on the surface of the first substrate SUB1 on the opposite side to the liquid crystal LC, and on the surface of the second substrate SUB2 on the opposite side to the liquid crystal LC. However, the configuration shown in FIG. 7, corresponding to FIG. 1, is also possible. In other words, a substrate reinforcing layer formed of a resin layer (second resin layer) RSL2 is formed on the surface of the first substrate SBU1 on the opposite side to the liquid crystal LC. Further, a substrate reinforcing layer formed of a resin layer (third resin layer) RSL3 is formed on the surface of the second substrate SUB2 on the opposite side to the liquid crystal LC. Because of these substrate reinforcing layers, the thinned substrates SUB1 and SUB2 can be resistant to bending or impact, respectively.

Also in the second embodiment, the resin layer RSL1 is interposed between the first substrate SUB1 and the TFT circuit layer CRL. This makes it possible to achieve the same effect of preventing the TFT circuit layer CRL from being cracked, as shown in the first embodiment.

In FIG. 8, the first substrate SUB1 and the TFT circuit layer CRL are combined with the resin layer SRL1 interposed between the first substrate SUB1 and the TFT circuit layer, and with the resin layer SRL2 formed on the surface of the first substrate SUB1 on the opposite side to the resin layer SRL1. Then, the combination of the first substrate SUB1 and the TFT circuit layer CRL are warped and projected on the side of the TFT circuit substrate CRL until the TFT circuit layer CRL is cracked. Here, the first substrate SUB1 has a thickness of 0.2 mm. Under the same conditions, the combination of the first substrate SUB1 and the TFT circuit layer CRL without the resin layer SRL1 interposed therebetween (in which the resin layer SRL2 is formed on the surface of the first substrate SUB1 on the opposite side to the resin layer SRL1) is warped and projected on the side of the TFT circuit layer CRL until the TFT circuit layer CRL is cracked. In this case, it has been observed that the amount of warpage of the former is up to about 1.5 times more than that of the latter. Further, the strength of the first substrate SUB1 has been tested by dropping an iron ball on the combination of the first substrate SUB1 and the TFT circuit layer CRL with the resin layer SRL1 interposed therebetween. In this test, it has been observed that the strength of the combination with the resin layer SRL1 interposed therebetween is almost six times more than the case in which the resin layer SRL1 is not interposed between the first substrate SUB1 and the TFT circuit layer CRL.

### Third Embodiment

Although the above embodiments show the liquid crystal display device, it is to be understood that the present invention is not limited to such a liquid crystal display device. The present invention can also be applied to other display devices, for example, such as an organic EL display device.

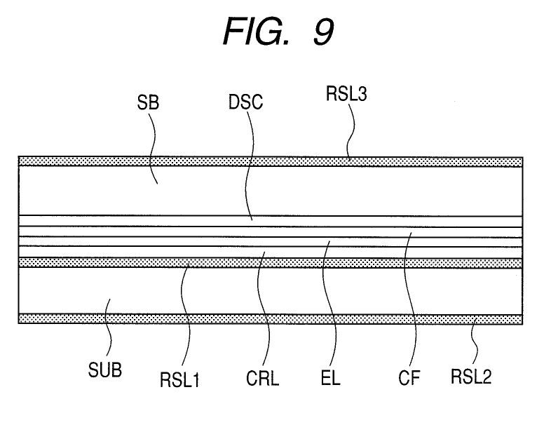

FIG. 9 shows, with reference to FIGS. 1 and 7, the configuration of an organic EL display device. In FIG. 9, first a substrate SUB is formed of glass. Then, a resin layer (first resin layer) RSL1 is formed on the main surface of the substrate SUB. A TFT circuit layer CRL is formed on the substrate SUB with the resin layer RSL1 interposed between the substrate SUB and the TFT circuit layer CRL. The function of the resin layer RSL1 is the same as the function of the resin layer RSL1 shown in the first embodiment. The TFT circuit layer CRL in the organic EL display device is formed by adding power supply signal lines, current control thin film transistors, and the like, to the TFT circuit layer CRL of the liquid crystal display device. Unlike the case of the liquid crystal, the organic EL element is formed as a self-light-emitting element whose emission luminance is controlled by electric current.

Plural organic EL elements EL are arranged in a matrix form on the upper surface of the TFT circuit layer CRL. The organic EL elements EL are independently driven by the TFT circuit CRL.

A color filter CF is formed on the upper surface of the individual organic EL elements EL. The color filter CF allows each organic EL element to make a color display.

A sealing board SB is disposed opposite to the substrate SUB. The sealing board SB is formed, for example, of glass, and has a function of preventing the organic EL elements EL from being exposed to the atmosphere. The sealing board SB is fixed to the substrate SUB with a desiccant DSC interposed therebetween.

It is to be noted that the color filter CF and the desiccant DSC are not necessarily required. Thus, these materials may not be used here.

Further, the resin layer (second resin layer) RSL2 is formed on the surface of the substrate SUB on the opposite side to the resin layer RSL1. Also, the resin layer (third resin layer) RSL3 is formed on the surface of the sealing board SB on the opposite side to the organic EL elements EL. This configuration is the same as the configuration in FIG. 7. The substrate SUB can be resistant to the bending or impact due to the resin layer RSL2. The sealing board SB can be resistant to the bending or impact due to the resin layer RSL3. However, similarly to the case of the first embodiment, the resin layers RSL2 and RSL3 are not necessarily formed here.

### Fourth Embodiment

Although the embodiments 1 and 2 show the liquid crystal display device of the so-called lateral electric field type, the present invention is not limited to this type. The present invention can also be applied to liquid crystal display devices of the so-called vertical electric field type, such as twisted nematic (TN) and vertical alignment (VA) devices.

While the present invention has been described with reference to certain specific embodiments, it should be clear that these are only examples, and the present invention is not limited to these embodiments. The present invention may be modified accordingly without departing from the technical spirit and scope of the present invention. The configurations described in the respective embodiments can be combined as long as they are consistent.

What is claimed is:

1. A display device comprising:
a first substrate;
a second substrate disposed opposite to the first substrate; and
a liquid crystal interposed between the first and second substrates,
wherein a TFT circuit layer is formed on a surface of the first substrate on the liquid crystal side,
wherein the first substrate is formed of glass, and
wherein the TFT circuit layer is formed on the first substrate with a first resin layer interposed therebetween.

2. The display device according to claim 1, wherein a second resin layer is formed on the surface of the first substrate on the opposite side to the first resin layer.

3. The display device according to claim 1, wherein the first substrate has a thickness of 0.2 mm or less.

4. The display device according to claim 1, wherein the first substrate has a thickness of 0.1 mm or less.

5. The display device according to claim 1,
wherein the second substrate is formed of glass, and
wherein a third resin layer is formed on a surface of the second substrate on the opposite side to the liquid crystal.

6. The display device according to claim 1, wherein the first and second substrates are warped and projected in a direction in which the TFT circuit layer is formed on the first substrate.

7. A display device comprising an organic EL display device,
wherein the organic EL display device is formed by laminating at least a TFT circuit layer, a plurality of organic EL elements driven by the TFT circuit layer, and a sealing board, in this order on one surface of a substrate,
wherein the substrate is formed of glass, and
wherein the TFT circuit layer is formed on the substrate with a first resin layer interposed therebetween.

8. The display device according to claim 7, wherein a second resin layer is formed on the surface of a substrate on the opposite side to the first resin layer.

9. The display device according to claim 7, wherein the substrate has a thickness of 0.2 mm or less.

10. The display device according to claim 7, wherein the substrate has a thickness of 0.1 mm or less.

11. The display device according to claim 7,
wherein the sealing board is formed of glass, and
wherein a third resin layer is formed on a surface of the sealing board on the opposite side to the organic EL elements.

12. The display device according to claim 7, wherein the substrate and the sealing board are warped and projected in a direction in which the TFT circuit layer is formed on the substrate.
